(19) United States
(12) Patent Application Publication
(10) Pub. No.: US 2016/0233756 A1
(43) Pub. Date: Aug. 11, 2016

(54) Apparatus Converting a Single Rotational Centrifugal Kinetic Energy to Multiple Electrical Generators

(71) Applicant: Francisco Guzman, HIALEAH, FL (US)

(72) Inventor: Francisco Guzman, HIALEAH, FL (US)

(73) Assignee: Luis Francisco Guzman, SR., Hialeah, FL (US)

(21) Appl. No.: 15/041,948

(22) Filed: Feb. 11, 2016

Related U.S. Application Data
(63) Continuation of application No. 14/731,637, filed on Jun. 5, 2015.

(51) Int. Cl. H02K 47/20; H02K 7/075; H02K 7/02

(52) U.S. Cl. CPC H02K 47/20; H02K 7/02; H02K 7/075; Y10S 74/09; H02K 53/00

(57) ABSTRACT

The present idea Invention is a kinetic technology directed to the conversion of mechanical energy to mechanical electric energy, The process of a centrifugal wheeled disk and a push & pressure-compression engine apparatus, configure to convert an internal force applied by a primary electrical motor connected to a rotatable top wheeled disk creating a centrifugal rotation which in return apply force to a platform which is coupled to the push-pressure compression engines. Members, connected to one another in succession will provide a clean source of energy taking advantage of the technical centrifugal system force and the push-pressure compression engine power system which includes a crankshaft that is one of the most important moving part in the engine. The crankshaft is a large component with a complex geometry in the engine which converts the reciprocating displacement of the piston to a rotary motion. The system of vertical push pressure though a piston to the crankshaft, created a horizontal rotational energy, and an generator configured to received the rotational mechanical energy generate a full scale commercial electrical power. The push & pressure compression engine is similar to a combustion engines. The difference is that this invention has no combustion. The centrifugal wheeled is what make this idea be special and because the pistons will work freely, minimizing the pressure required to depress the actuation members, introducing the rapid movement of the passing rotating wheels gradually into the system by pressure the lever actuation member projected about the circular platform surface. Dealing with a rotating frame of reference with Newton's laws of motion artificially valid, one can add fictitious forces that are assume to be the cause of acceleration. In particular, the centrifugal acceleration is added to the motion of every object, and attributed to a fictitious centrifugal force.

This centrifugal force is a sufficient correction to Newton's second law only if the body is stationary in the rotating frame. For bodies, the move with respect to the rotating frame it must be supplemented with a fictitious Coriolis force. For example, a body that is stationary relative to the non rotating frame, will be rotating when viewed from the rotating frame. The centripetal force of −MW²R, required to account for this apparent rotation is the sum of the centrifugal force (MW²R,) and the Coriolis force (MW X U=−MW²R,). Since this centripetal force includes contribution from only fictitious forces, it has no reactive counterpart. The assumed centrifugal force can be described by potential energy of form Ep×−½MW²R,.

### STATEMENT REGARDING FEDERALLY SPONSORED RESEARCH OR DEVELOPMENT

“NO APPLICABLE”.

### THE NAME OF PARTIES TO A JOINT RESEARCH AGREEMENT

“NO APPLICABLE”.

### INCORPORATION-BY-REFERENCE OF MATERIALS SUBMITTED ON A COMPASS DISC. OR AS A TEX FILE VIA THE OFFICE ELECTRONIC FILING SYSTEM (EFS-WEB)

“NO APPLICABLE”.

### STATEMENT REGARDING PRIOR DISCLOSURES BY THE INVENTOR OR A JOINT INVENTOR

“NO APPLICABLE”.

### BACKGROUND

The present invention relates to energy.

There remain numerous publications describing apparatuses that generate electricity from natural gas, sun, sea tide, wind, etc.

Energy cost have rising and the environmental aspect of power production are more critical than ever before, it have become necessary to develop others avenue for the production of electricity and other form of energy.

Recognized source of potential power have been issued for devices such as theses, none been apparently commercially successful. Among the factors contributing to the lack of the power conversion of the prior art, the following are believed to be insignificant.

1. They are inefficient in that they recovery small portion of energy from continue movement crated from different sources.

2. They are inefficient in that they only are capable of producing small small amount of useful work.

3. They are unreliable in the critical components are subject to breakage and/or excessive wear from shock loading.

Throughout history, energy has been produced in various systems, the most common being the utilization of fossil fuels, gas, geothermal, nuclear, hydraulic and coal. Combustion engines, the most popular mechanism for producing electricity, utilizes fossils fuels such as oil, diesel, gas, vapor, geothermal, biodiesel, and garbage recycling, most of which cause harmful emission into environment.

Thus there is a need for a economical centrifugal generator power system that efficiently produce meaningful amounts of power, that is reliable, long-lasting, ease to install, and inexpensive to produce. This overcomes the disadvantage of prior art.

### SUMMARY

There are two keys in this kinetic idea-invention. The first is the Circular Centrifugal Wheeled Rotation Disk. The second is the Reciprocating Engine, name in this art as the Push-Pressure Compression Engine. The presented idea/invention meets the need for a perpetual motion by providing energy throw a push & pressure-compression engine for actuating the centrifugal wheeled clock wise rotation on a circular platform creating a self induce movement. Multiplying the primary energy needed from a battery bank, (i/e different sources) which provided enough power to replenish its batteries plus produce usable energy for residential/commercial use. The circular wheeled rotation disk on the surface, comprising: an actuation member supported for movement between a first position projecting 100% over surface and second substantially flush of the surface; means permitting movement of the actuation member to the second position thereof in response to engagement of the actuation member by rotating centrifugal wheels; a actuation member, a rotatable drive crankshaft, the pistons coupled between the actuation member and the drive crankshaft for imparting unidirectional motion in response to repetitive movement of the actuation member between the first, second, and multiple positions.

In some embodiments, the torque limiting device can also function with a regular combustion, or a pneumatic engine. At the centrifugal energy apparatus a lever ramp located on the surface of a circular platform, and a centrifugal wheels disk (guide by a central electric motor) rotated on the platform pushes and presses the lever ramp device as first step. The wheels rollover the lever ramp created a vertical push, which subsequently pushes the piston cylinder downward wich is tied to the crankshaft by means of a race. This created a horizontal, circular rotation. Followed by the second piston, the third, and so on. The sequence following by the second piston, and so on, in sequence of the pistons return forceful to their primary anterior position guided by the crankshaft, creating an rpm. The torque and the horse power necessary for the movement of a generator for production of electricity.

### BRIEF DESCRIPTION OF SEVERAL VIEWS OF THE DRAWINGS

FIG. 1—For a better understanding, I have illustrated the function of the system using a single piston to show the push pressure compression, and components use according to the present invention.

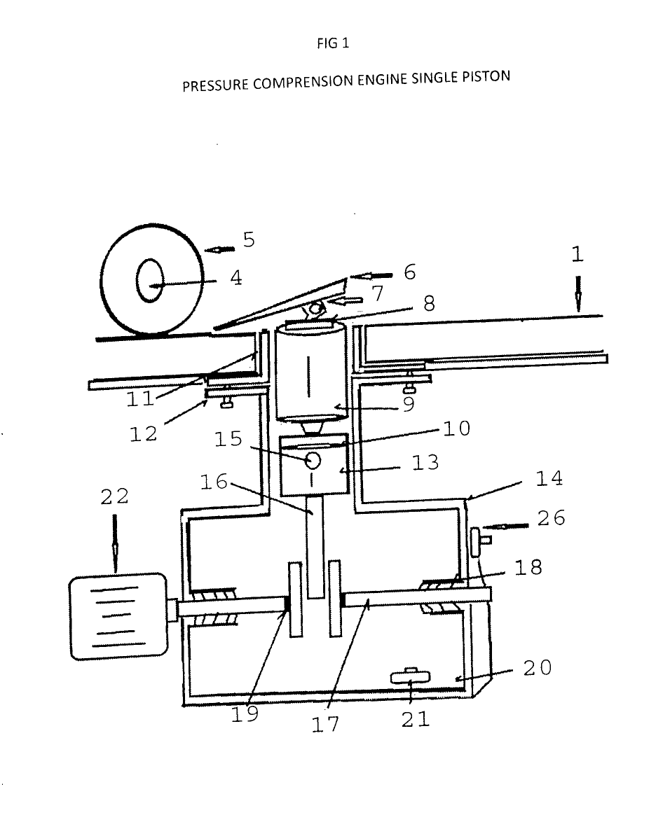

FIG. 2—Show the bottom side of the flywheel disk.

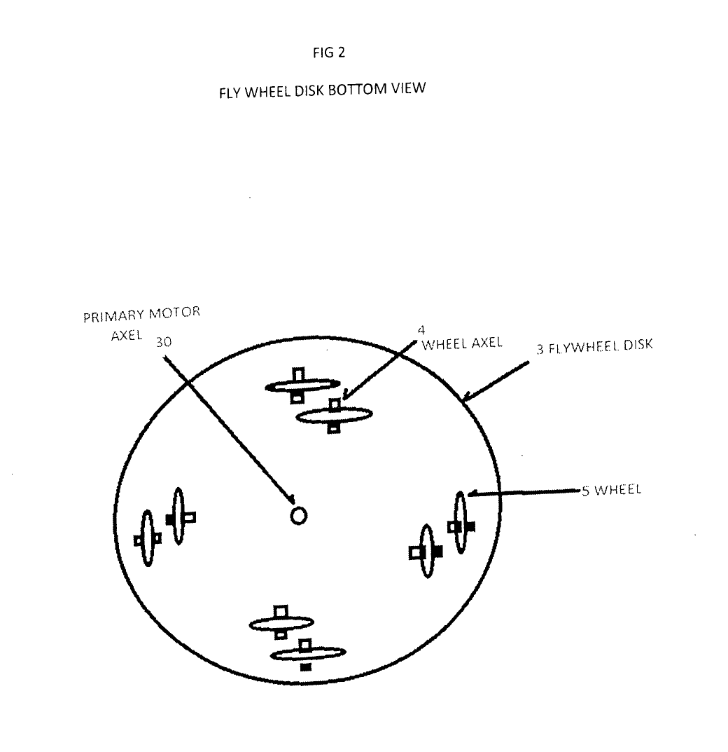

FIG. 3—Show the top face side of the circular platform.

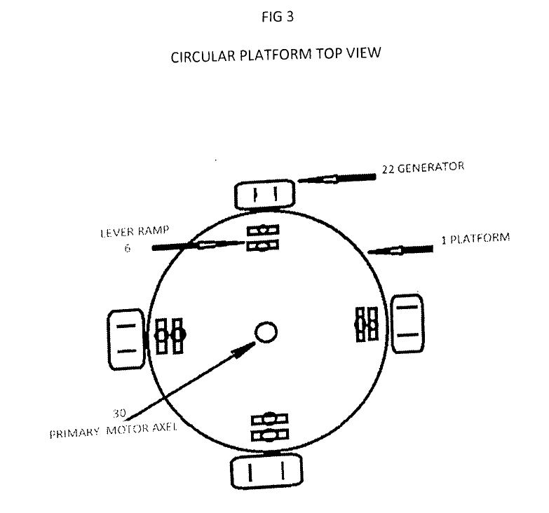

FIG. 4—Show the bottom face side of the platform.

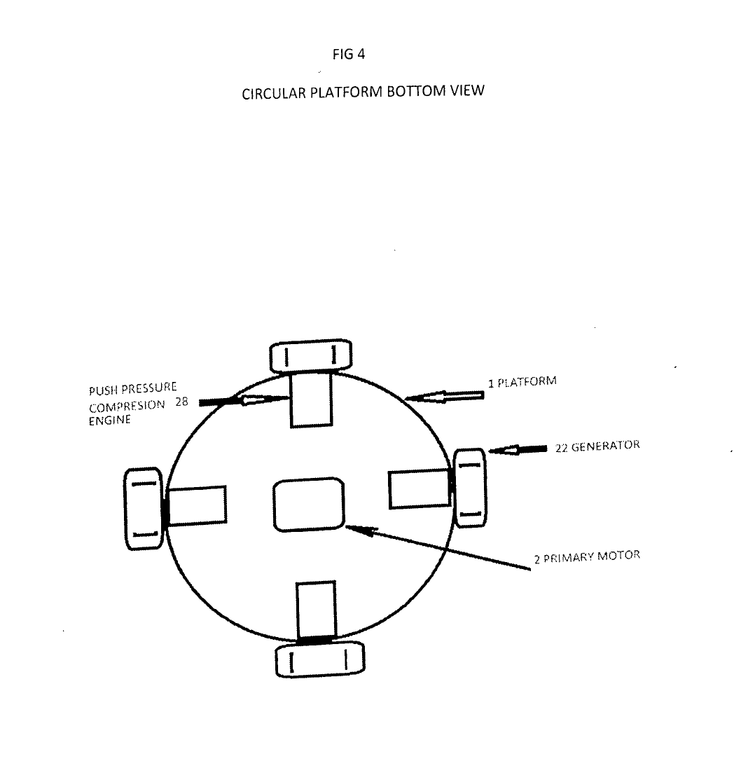

FIG. 5—Show the embodiment of a two piston push pressure compression engine coupling to a generator representative of the present art.

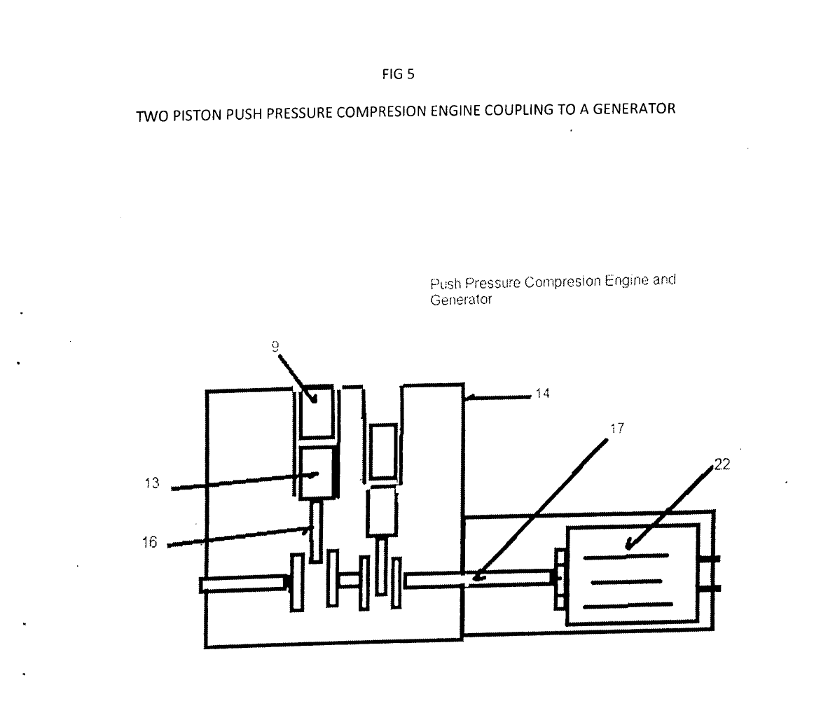

FIG. 6—Show another view of the above mentioned embodiments, as a completed system, installed with the generator.

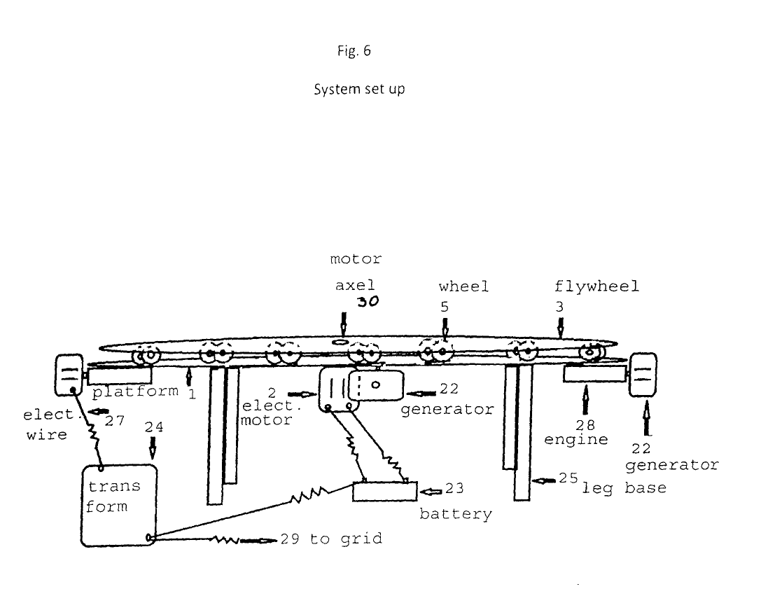

### DETAILING DESCRIPTION OF INVENTION

This idea in generally visually presented a circular platform with multiple engines and generators making work by a single electric motor, with multiple engine and generators increasing the electric production by the creation of the present art, base in this technology the electricity created will be superior to the one provided by the primary single electric motor (2).

A first embodiment, the platform, member 1, a (circular platform), where member 2, (electric motor), is attach to the center of member 1, member 3 a rotatable top portion (fly wheel disk) attach to axel of member 2, member 4 (wheel axel) attach to member 3, attach and holding member 5 (wheels) which rest and roll the wheels on member 1.

The rotatable fly wheel disk components are, a circular disk with multiples wheels positioned in different areas depending of how many pistons the push pressure compression engine has for the production of electricity. The sample of the present invention are two piston, but could be several more, and is controlled by the electric motor mounted in the center of the platform (1), which produce the rotation of the fly wheel (3) attach to the axel of the electric motor (2).

The second embodiment a push pressure compression engine member 28, the member 12 (head block), is attach under member 1 (circular platform). Member 12 is attach to member 14 (block), the member 6 (lever ramp portion) plunger the attach member 7. Plunger member 8, and member 9 (secondary piston) attach to member 13 (primary piston), attach to member 16, (rod), This will be held together with a ping member 15 Member 15 is attach to the member 16, which will be hold to a member 17, (crankshaft) by member 19 (crankshaft bearings). The member 17 (crankshaft), will be rest on the member 14 (engine block) by the member 18 (block holder bearings), following by 22 (the generator).

A push-pressure compression engine (28) installed under the circular platform, where an actuation members 5, 6, 7, 8, and 9 is supported. Movement between a first position projecting 100% substantially three (3) inches over the platform surface (1). A second position, projecting substantially flush on the surface, subsequently, this positions is developed by the manufacturers ratio of the crankshaft (17), which provide different circular degree position for each piston members. This produces torque, rpm, and horsepower. This also guarantees the response to repetitive movement of the actuation members, and the return of each member to their original working position. The amount of reaction that the centrifugal wheels (5) experience when encountering the actuation member (6) is increase. The speed of the passing wheels (5) is introduced into the system gradually.

The rotatable circular fly wheel disk (3) with the wheels (5). Is shown with the weight and circular forward motion, i.e., momentum, of the rotating wheel (5) depresses an actuation members 6, 7, 8, 9 until next actuation member is ready in the second position with the platform surface (1). The centrifugal wheels (5), rolls over the actuation lever members (6) and encounter a second actuation member. This is action is repeated on multiple actuations with multiple wheels an so on. After a wheel 5 rolls off of an actuation lever member 6, the crankshaft member (17) forces the actuation members to the next ready to be depressed position. When multiple action members are used, each one can move with the command order from member 17, the last member can turn and pressure the member 17 to the ready following position.

Multiple push-pressure compression engine (28) installed under the circular platform (1). The push & pressure-compression engine system for actuation by wheeled centrifugal traveling over a surface platform, comprising; (a) attain for installation beneath the surface; (b) multiple actuating members supported for individual relative to the engine between their respective first position projecting over the surface and respective second position when the engine is installed beneath the surface platform, the actuation members will each having a substantially rectangular upper pedal like lever protruding the surface, the wheel-contacting surfaces is projecting a path of centrifugal wheels during sequential movement of the actuating members from the first position to second position. (a) the crankshaft permitting movement of the actuation members to the second position thereof in response to sequential engagement of the actuation members by passing centrifugal wheels; (b) a crankshaft rotating relative to the engine block installed under the surface. When the engine block is installed beneath the surface platform; the crankshaft in response to repetitive movement of the actuation members between the first and second position. (d) The electric generator is producing electrical power in response to rotation of the crankshaft.

Although the present invention has been described in considerable detail with reference to certain preferred versions, other versions are possible. For example, multiple actuation members can be used in the centrifugal push & pressure-compression engine. Therefore, the spirit and scope of the appended claims should not necessarily be limited to the description of preferred version contained here.

The present invention is directed to produce electricity through a centrifugal and push & pressure-compression engine system idea, for actuation by wheeled clock wise centrifugal such as rotating wheels traveling over a platform surface (1). The push & pressure-compression engine converts the vertical push to horizontal momentum and downward forces of the wheels 5 into circular motion capable of driving a the crankshaft (17), which can used for generating electricity throw the generator (22) wired to one another and directed to the transformer. The transformer multiplies the electricity which is send to the grid (29).

The actuation member 6 (lever ramp), comprise the (rigidly connected) guided member 7 (ping axel), and 8 (coupling), connected to member 9 (piston extension adapted) to member 13, (primary piston) to member 16 (push rod), connected to member 17 (crankshaft) making turn the crankshaft, connected to member 22 (the generator).

The actuation members 6, 7, 8, and 9 can be a plunger or any other actuation member known in the art, the actuation lever member 6 preferably is a rectangular ramp, wheel-contacting surface of the actuation member 5 that is adapted for orientation substantially horizontal label to project path of passing wheels (5). The portion of the wheel-contacting surface (1) is preferably a lever ramp for facilitating smooth passage of wheels (5) during movement of the actuation members 6, 7, 8, and 9 from the first position to the second position.

The member 13 (primary piston) is attach by member 16 (push rod), which will be connected by a ping member 15, the member 16 (push rod) will be hold to a member 17 (crankshaft) by member 19 (push rod bearing), the member 17 will be hold and rest on the member 14 (engine block) and the member 18 (block bearing holder).

The interior mechanical system will be lubricated with oil, that be deposit on the member 20 (oil pan), which will irrigate through all the interior by the member 21 (oil pump).

The member 26 (water pump) installed on the member 14 (block engine), prevent the overheating of the engine.

The member 12 (engine head block), installed on top of the member 14 (engine block), is connected under the member 1 (circular platform), member 11 (cylinder adaptor), installed on top of the member 12 (engine head block), which reached the platform surface.

The member 10 (oil ring) will be installed on member 13 (primary piston).

The actuation members 6 can be one of many, such as four, six or eight, depending on the engine block used. The actuating members along a circular platform surface (1) for serial sequential engagement by the passing rotating wheel (5). The plurality of actuation members preferably spaced as close together as practical. In some embodiments, the space between lever actuation members can be inches as an example.

Finally the generators (22) are electrically wired (27) to one another and tide to the electrical transformer (24), which provide the needed electricity of the battery bank (23) for a continues work, (perpetual motion) and the surplus of the electricity will go to the grid.

All the features disclosed in the specification above, including the claims, abstracts, and drawings, and all steps in any method or notices disclosed, may be combine in any combination, except combinations where at least some of such features and/or steps are mutually exclusive. Each feature disclosed in the specification, including the claims, abstract, and drawings, can be replace by alternative features serving the same purpose, unless expressed otherwise. Thus, unless expressed otherwise, each feature disclosed is one example only of a generic series of equivalent similar feature.

An element in claim that does not explicitly state “means” for performing a specified function or “step” for performing a specified function, should not be interpreted as a “means” for “step” clause as specified in U.S.C. .sct. 112.

### LISTING SEQUENCE

### Detailed Reference of Components Members

Circular platform # 1
Primary electric motor # 2
Flywheel disk # 3
Wheels axel # 4
Wheels # 5
Lever ramp # 6
Lever ramp axel # 7
Connection device # 8
Piston adaptor # 9
Oil rings # 10
Cylinder adaptor # 11
Head top # 12
Primary piston #13
Engine block # 14
Piston Ring #15
Push rod # 16
Crankshaft # 17
Crankshaft holder # 18
Push rod bearings # 19
Oil pan # 20
Oil pump # 21
Generator # 22
Batteries # 23
Electric transform # 24
Stan # 25
Water pump # 26
Electric wire #27
Push pressure compression Engine #28
Grid #29

1. An apparatus for converting a single rotational kinetic energy to electrical power, the apparatus comprising:
a plurality of actuation members each comprising a lever ramp;
a platform having a top surface, the platform comprising a plurality of openings to receive the plurality of actuation members;
an electric motor;
a circular flywheel attached to the electric motor axel;
a circular flywheel driven by the electric motor;
a plurality of wheel axels attached to the flywheel;
a plurality of wheels attached to the plurality of wheel axels;
a plurality of pistons attached to the plurality of actuation members;
a plurality of crankshafts connected to the plurality of pistons through a plurality of push rods and a plurality of crankshaft bearings; and
a plurality of generators connected to the plurality of crankshafts;
wherein the plurality of wheels roll on the top surface of the platform or on top surfaces of the lever ramps of the plurality of actuation members;
wherein each of the lever ramps is movable over a limited range between a first end position and a second end position;
wherein each of the lever ramps is entirely above the top surface of the platform and is not depressed by the plurality of wheels at the first end position;
wherein each of the level ramps is substantially flush with the top surface of the platform and is depressed by the plurality of wheels at the second end position; and
wherein the plurality of generators generate electricity through rotations of the plurality of crankshafts, linear motions of the plurality of pistons, and deformations of the lever ramps, of the plurality of actuation members.

2. The apparatus of claim 1, wherein the plurality of actuation members are equally spaced along a circumference having predetermined radius; and wherein the plurality of wheels are equally spaced along another circumference having the predetermined radius.

3. The apparatus of claim 1, wherein the first subset of plurality of wheels are equally spaced along a first circumference having a first radius; wherein the second subset of the plurality of wheels are equally spaced along a second circumference having a second radius and; wherein the first radius is large than the second radius.

4. The apparatus of claim 1, wherein each of the plurality of actuation members further comprise a lever axel, a connection device, and a piston adapter.
